(19) United States
(12) Patent Application Publication
(10) Pub. No.: US 2011/0214299 A1
(43) Pub. Date: Sep. 8, 2011

(54) CIRCLE CUTTER

(76) Inventor: MOON HEH, Taipei (TW)

(21) Appl. No.: 12/716,266

(22) Filed: Mar. 2, 2010

(51) Int. Cl. B26B 27/00

(52) U.S. Cl. 30/310; 83/596

(57) ABSTRACT

A circle cutter has a hand crank, a center positioning unit and a cutter unit. The center positioning unit is mounted on one end of the hand crank and has an awl-free foot positioning a center of a circle to be cut or drawn without generating a pierced hole. The cutter unit is mounted adjustably on the hand crank and has a cutting depth adjustable assembly providing multiple cutting depths for cutting things with different thickness. Therefore, to cut or draw a circle with the circle cutter is hole-free, labor-saving and flexible.

### BACKGROUND OF THE INVENTION

1. Field of the Invention

The present invention is related to a circle cutter, and more particularly to a circle cutter having a non-piercing center spike and an adjustable cutting depth.

2. Description of the Related Art

With reference to FIGS. 12 to 14, a conventional circle cutter has a ruler arm (6), a blade unit (7), a movable center spike (8) and a protection cover (9). The ruler arm (6) has two types of scales, namely, metric and imperial scales. The blade unit (7) perpendicularly extends from one end of the ruler arm (6), and has a blade (71) mounted securely on a bottom end of the blade unit (7). The movable center spike (8) has an awl (81), a slider (82), a lock (83) and a handle (84). The awl (81) is securely mounted in a bottom of the movable center spike (8) to position a center of a circle. The slider (82) is mounted slidably on the ruler arm (6) and can be positioned at a position on the ruler arm (6) as a center of a circle to be cut. Thus, the distance between the awl (81) and the blade (71) is the radius of the circle to be cut. When a center and a radius of the circle to be cut are located, the lock (83) on a rear side of the slider (82) is pressed down to lock the slider (82) and position the awl (81). The handle (84) is held to rotate the blade unit (7) against the object to be cut with respect to the awl (81). The protection cover (9) is used to cover and prevent the blade (71) and the awl (81) from injuring people and from being damaged.

The conventional circle cutter is disadvantageous in that the awl (84) surely generates a hole at the center of the cut circle, so the appearance of the cut circle is not aesthetic. Additionally, the cutting depth of the blade (71) into an object is not adjustable, so the conventional circle cutter cannot be applied to cut an object having a thickness larger than the predetermined cutting depth of the conventional circle cutter. Moreover, the way of holding the handle (84) to cut an object is not good for cutting an object with a thick thickness. Therefore, the conventional circle cutter is not versatile and convenient in use.

### SUMMARY OF THE INVENTION

An objective of the present invention is to provide a circle cutter having no piercing hole at the center of a circle to be cut or drawn and ensuring adjustable cutting depth and labor-saving operation.

To achieve the foregoing objective, the circle cutter has a hand crank, a center positioning unit and a cutter unit. The hand crank has a ruler arm, a pivot hole, a hand knob and a central slot. The pivot hole is formed through one end of the ruler arm. The hand knob is mounted on the other end of the ruler arm. The central slot is formed through the ruler arm and located between the pivot hole and the hand button.

The center positioning unit mounted on the end of the ruler arm in which the pivot hole is formed to position a center of a circle and has foot and a center knob. The center knob is mounted through the pivot hole of the ruler arm and is connected to the foot.

The cutter unit has a base, a base locker and a cutting depth adjustable assembly. The base has a dome-like wall and a tubular cutter holder. The dome-like wall is formed on the base and has an opening and a ruler slot. The opening is formed through a top and a side of the dome-like wall. The ruler slot is formed through the dome-like wall and is opposite to the side of the dome-like wall in which the opening is defined. The tubular cutter holder is formed on the base and has a top end and a bottom end protruding respectively from a top and a bottom of the base and a blade hole formed through the tubular cutter holder. The top end of the tubular cutter holder is located within the dome-like wall, is mounted slidably in the central slot of the ruler arm, and has an outer thread formed around the top end.

The base locker has a top bore and an inner thread and is screwed with the tubular cutter holder to abut against the ruler arm so as to fix the ruler arm on the base.

The cutting depth adjustable assembly is mounted in the tubular cutter holder and has a replaceable tool, a tubular guide, a spring and a cutting depth selector. The tubular guide has multiple flat portions formed on a top of the tubular guide and multiple sloped portions spirally formed on the top of the tubular guide between the flat portions. One end of the spring is detachably inserted into a top of the replaceable tool, and the other end of the spring is securely inserted into a bottom of the tubular guide. The cutting depth selector has a dial, a necked cylinder and a protrusion. The necked cylinder is partially mounted in the base locker, and is partially mounted through the top bore of the base locker and co-axially fastened on a bottom of the dial. The protrusion is formed on a bottom of the necked cylinder, and abuts the top of the tubular guide so as to alternatively rest on the flat portions and move along the sloped portions of the portion of the tubular guide when the dial is rotated.

The present invention employs an awl-free positioning unit to exempt from a hole pierced at a center of a circle to be drawn or cut. Multiple cutting depths can be chosen for cutting objects with different thickness, and the circle cutter is versatile in use. As the hand knob is mounted on the ruler arm and rotated with respect to the center positioning unit, a torque is generated to facilitate the cutting when a force is applied to the hand knob, thereby achieving a labor-saving operation in cutting.

### BRIEF DESCRIPTION OF THE DRAWINGS

FIG. 1 is a perspective view of a circle cutter in accordance with the present invention;

FIG. 2 is a partially exploded perspective view of the circle cutter in FIG. 1;

FIG. 3 is another partially exploded perspective view of the circle cutter in FIG. 1;

FIG. 4 is an exploded perspective view in partial section of the circle cutter without a protection guard in FIG. 1;

FIG. 5 is an enlarged exploded perspective view of a cutting depth adjustable assembly of the circle cutter in FIG. 4;

FIG. 6 is an exploded perspective view of another embodiment of a cutting depth adjustable assembly of a circle cutter in accordance with the present invention;

FIG. 7 is a perspective view of the cutting depth adjustable assembly in FIG. 5;

FIG. 8 is an operational perspective view of the cutting depth adjustable assembly in FIG. 7 showing the cutting depth being adjusted;

FIG. 9 is another operational perspective view of the cutting depth adjustable assembly in FIG. 7 showing the cutting depth being further adjusted;

FIG. 10 is an operational perspective view of the circle cutter without the protection guard in FIG. 1 showing the circle cutter being operated to cut a circle;

FIG. 11 is another operational perspective view of the circle cutter without the protection guard in FIG. 1 showing the circle cutter being operated to cut a circle;

FIG. 12 is an exploded perspective view of a conventional circle cutter in accordance with the prior art;

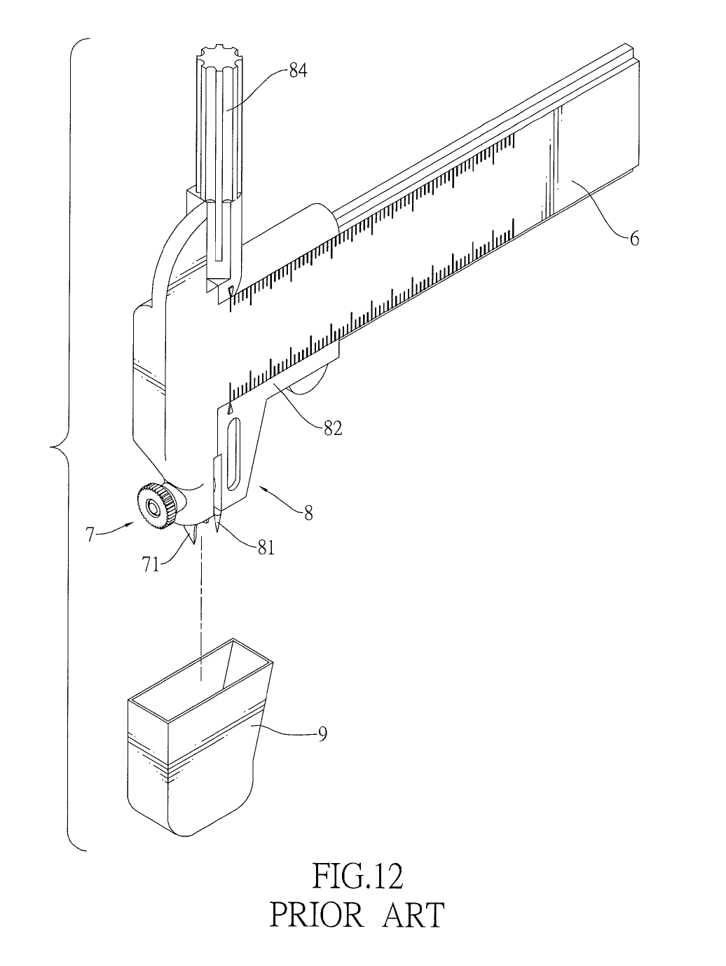

FIG. 13 is a perspective view of the conventional circle cutter without a protection cover in FIG. 12 with the position of the slider being adjusted; and

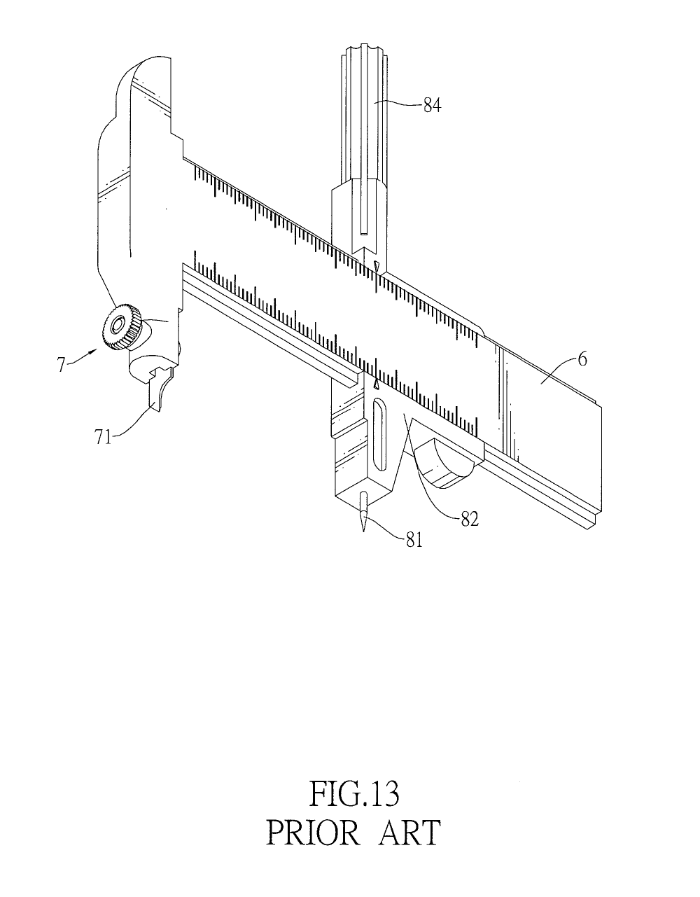

FIG. 14 is another perspective view of the conventional circle cutter in FIG. 13.

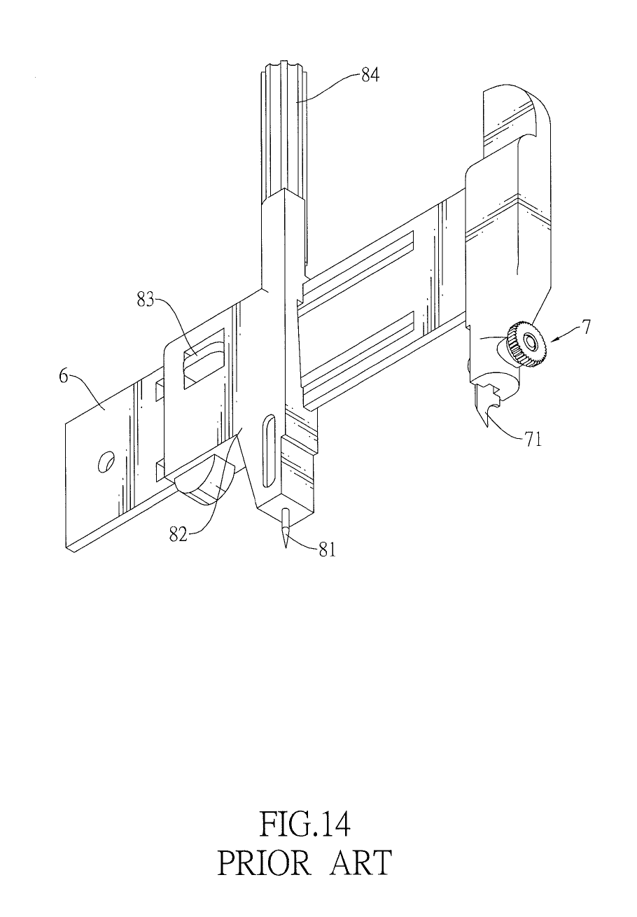

### DETAILED DESCRIPTION OF THE INVENTION

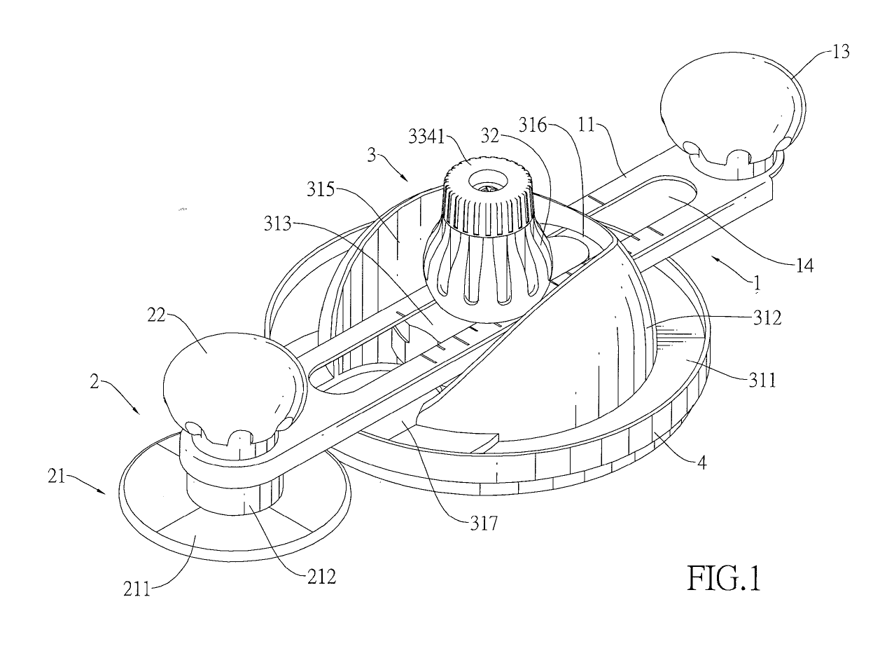

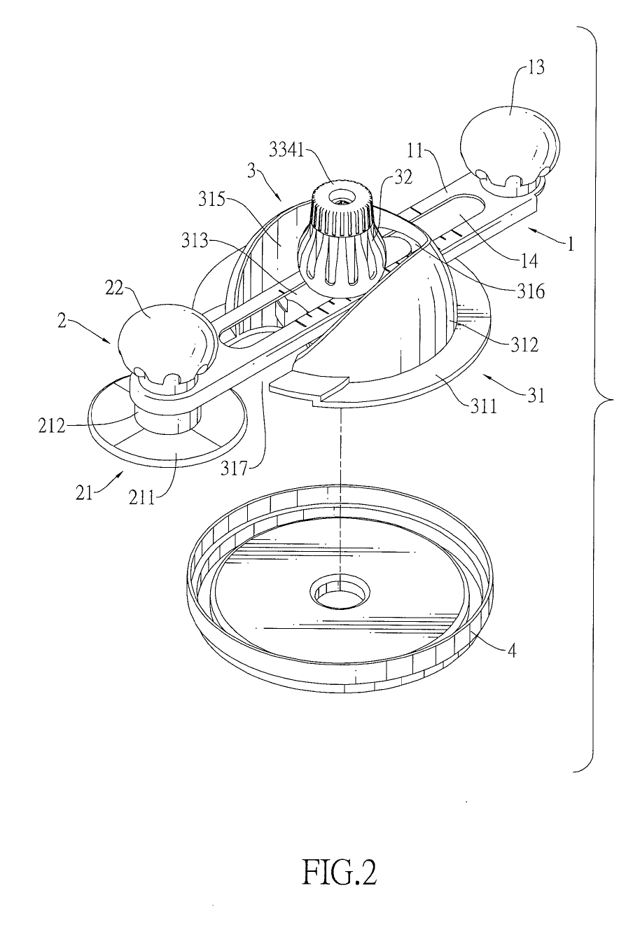

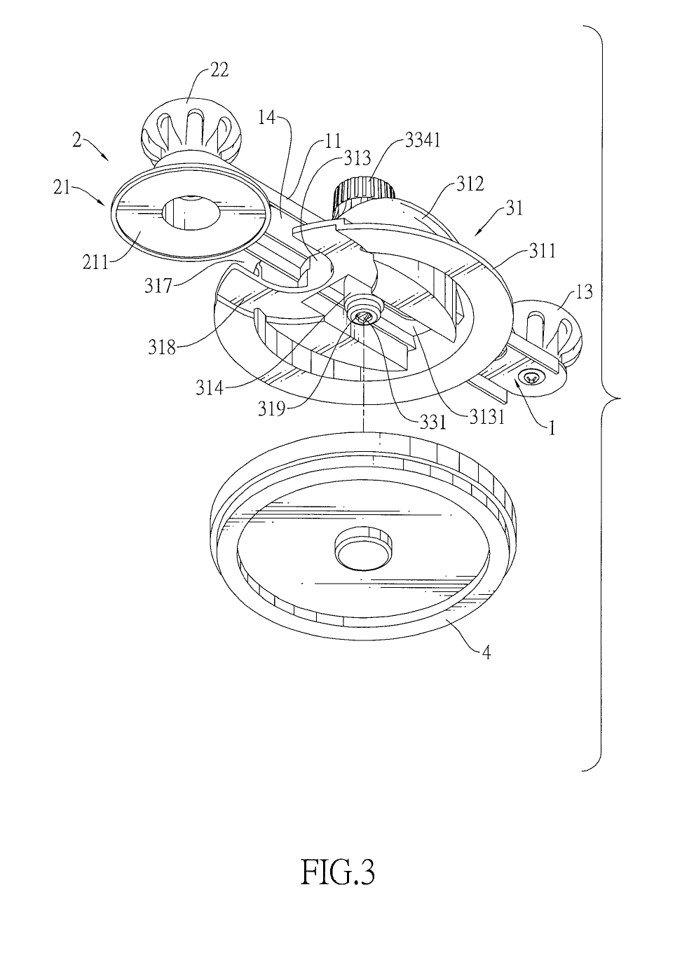

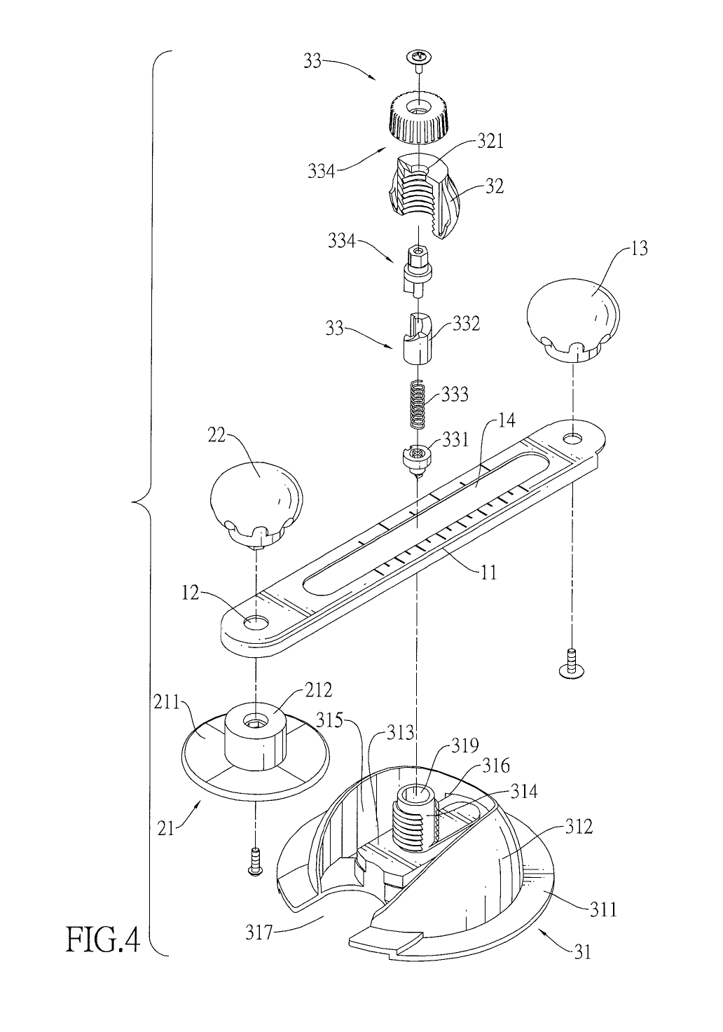

With reference to FIGS. 1 to 4, a circle cutter in accordance with the present invention has a hand crank (1), a center positioning unit (2), a cutter unit (3) and a protection guard (4).

The hand crank (1) has a ruler arm (11), a pivot hole (12), a hand knob (13) and a central slot (14). The ruler arm (11) has at least one scale unit that may be metric or imperial scale unit. The pivot hole (12) is formed through one end of the ruler arm (11). The hand knob (13) is mounted on the other end of the ruler arm (11). The central slot (14) is formed through the ruler arm (11) between the pivot hole (12) and the hand button (13).

The center positioning unit (2) serves to position a center of a circle, is mounted on the end of the ruler arm (11) in which the pivot hole (12) is formed and has a foot (21) and a center knob (22). The foot (21) has a round base (211) and a neck (212). The neck (212) is centrally formed on the round base (211). The foot (21) may be transparent and have cross indicia printed on the round base (211). The center knob (22) is mounted through the pivot hole (12) of the ruler arm (11) and connected to the foot (21).

The cutter unit (3) is mounted adjustably on the ruler arm (11) and has a base (31), a base locker (32) and a cutting depth adjustable assembly (33).

The base (31) has a disk (311), a dome-like wall (312), a raised block (313) and a tubular cutter holder (314). The disk (311) has a notch (317) and a circular recess (318). The notch (317) is formed through an edge of the disk (311). The circular recess (318) is formed in a bottom of the disk (311) and around the notch (317). The dome-like wall (312) is formed on the disk (311) and has an opening (315) and a ruler slot (316). The opening (315) is formed through a top and a side of the dome-like wall. The ruler slot (316) is formed through the dome-like wall (312) and is opposite to the side of the dome-like wall (312) in which the opening (315) is defined. The raised block (313) is formed on the disk (311) and within the dome-like wall (312) and has a recessed bottom (3131) formed in a bottom of the raised block (313). The tubular cutter holder (314) is mounted on the raised block (313) and has a top end and a bottom end protruding respectively from a top and the recessed bottom (3131) of the raised block (313) respectively. The top end of the tubular cutter holder (314) is located within the dome-like wall (312) and is mounted slidably in the central slot (14) of the ruler arm (11). The tubular cutter holder (314) has a blade hole (319) formed through the tubular cutter holder (314) and an outer thread formed around the top end of the cutter holder (314). The ruler arm (11) is slidably mounted on the raised block (313) and extends through the opening (315) and the ruler slot (316). When the ruler arm (11) is moved in a direction to make the center positioning unit (2) close to the cutter unit (3)dome-like, the neck (212) of foot (21) is held in the notch (317) and the round base (211) is partially received in the circular recess (318). Accordingly, the volume of the circle cutter can be reduced, and the space for transporting or storing the circle cutter can also be reduced.

The base locker (32) has a top bore (321) and an inner thread (322), is screwed with the top end of the tubular cutter holder (314) to abut against the ruler arm (11) so as to fix the ruler arm (11) on the raised block (313) of the base (31).

The cutting depth adjustable assembly (33) is mounted in the tubular cutter holder (314) and has a replaceable tool (331), a tubular guide (332), a spring (333), and a cutting depth selector (334).

The tubular guide (332) has multiple flat portions (3321) formed on a top of the guide (332) and multiple sloped portions (3322) spirally formed on the top of the guide (332) between the flat portions (3321). One end of the spring (333) is detachably inserted into the replaceable tool (331), and the other end of the spring is securely inserted in a bottom of the tubular guide (332).

The cutting depth selector (334) has a dial (3341), a necked cylinder (3342) and a protrusion (3343). The necked cylinder (3342) is partially mounted in the base locker (32), and partially mounted through the top bore (321) of the base locker (32) and co-axially fastened on a bottom of the dial (3341). The protrusion (3343) is formed on and protrudes from a bottom of the necked cylinder (3342), and abuts with the top of the tubular guide (332), so as to alternatively rest on the flat portions (3321) and move along the sloped portions (3322) of the tubular guide (332) when the dial (3341) is rotated.

The protection guard (4) is covered on a bottom of the base (31) and the replaceable tool (331) of the cutter unit (3) to prevent the replaceable tool (331) from cutting things or from being damaged.

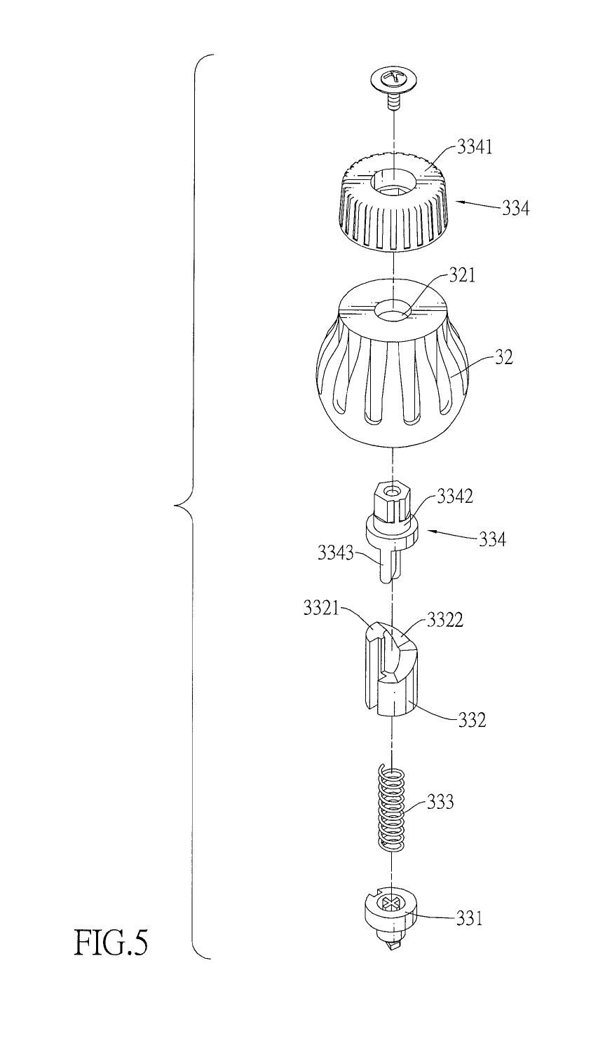

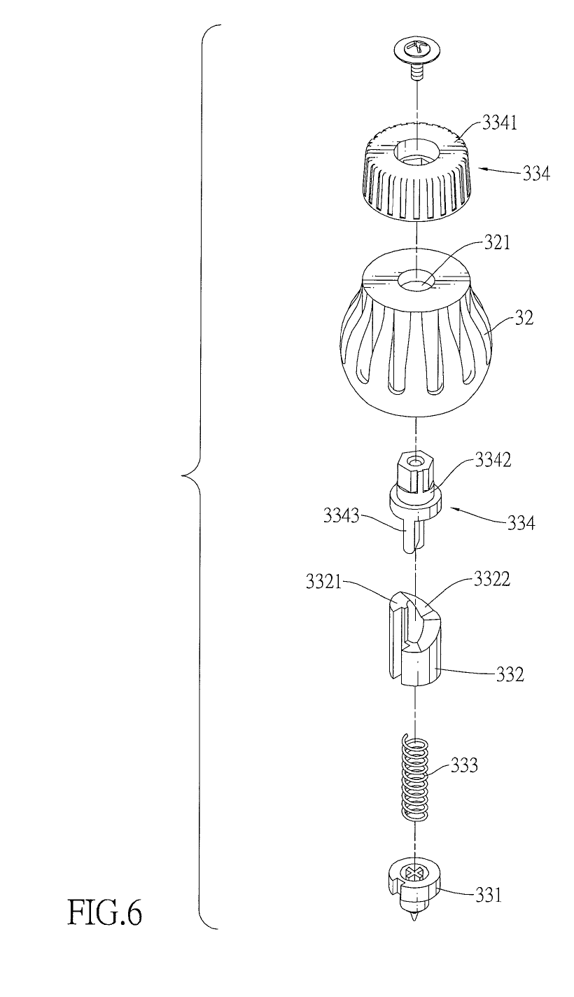

Depending on a cutting or drawing purpose, a corresponding replaceable tool (331) is adopted. With reference to FIG. 5, the replaceable tool (331) is a blade. The blade is connected to the spring (333) of the cutting depth adjustable assembly (33) at a top portion of the blade. Similarly, with reference to FIG. 6, the replaceable tool (331) is a pencil. The pencil is connected to the spring (333) of the cutting depth adjustable assembly (33) at a top portion of the replaceable pencil.

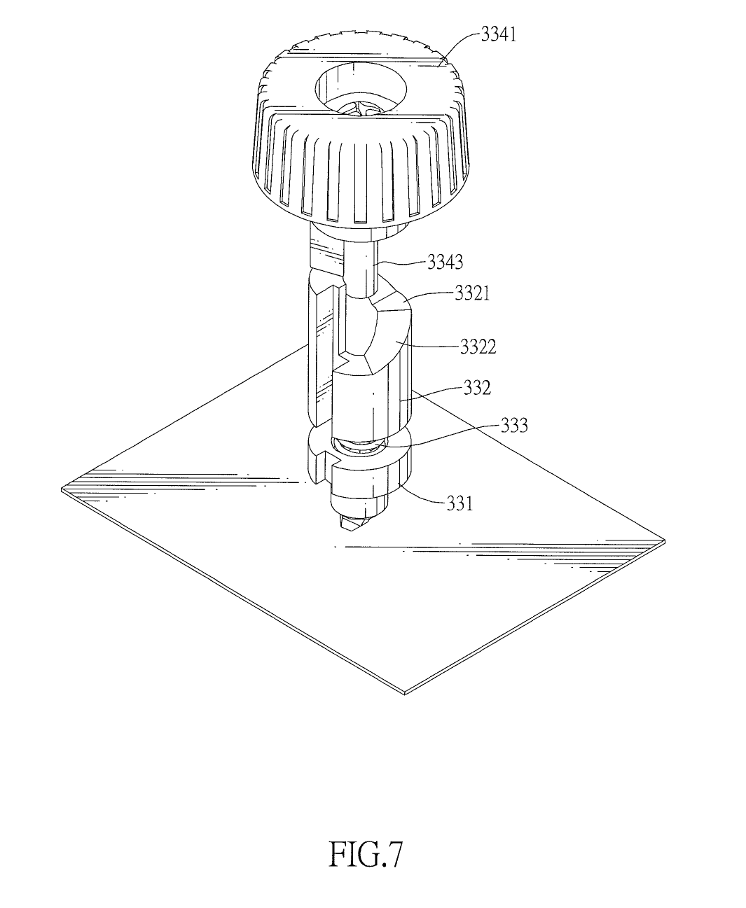

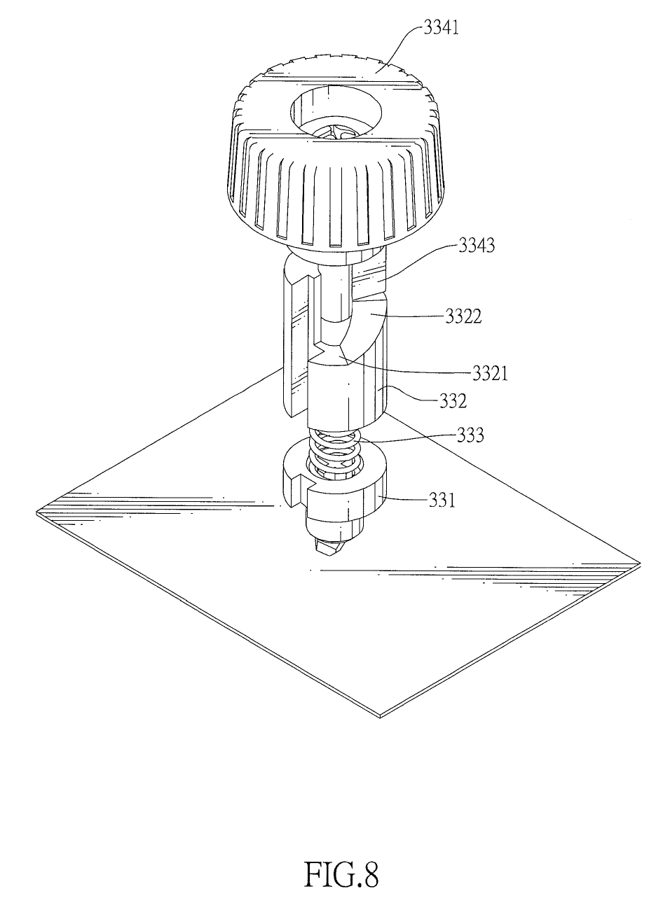

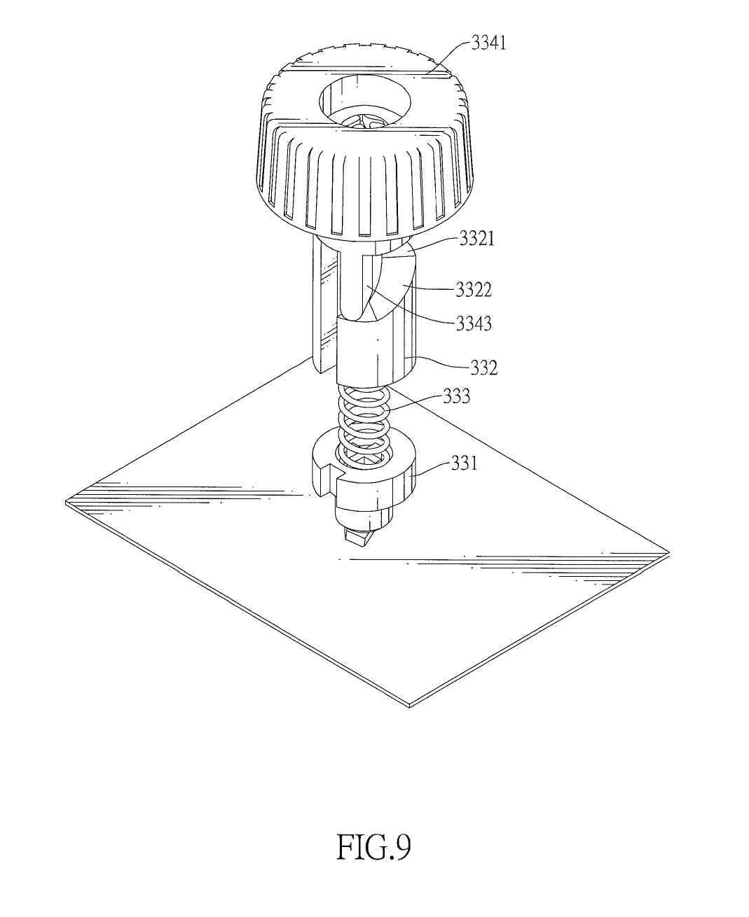

Depending on the thickness of the object to be cut, an appropriate cutting depth is set up before the cutting process. With reference to FIGS. 7 to 9, to set up the cutting depth, the dial (3341) is rotated to drive the protrusion (3343) to move along the top of the tubular guide (332). When the dial (3341) is rotated clockwise, the protrusion (3343) is moved along the flat portions (3321) and the sloped portions (3322) on the top of the tubular guide (332) and the tubular guide (332) is pushed to move downward. When the dial (3341) is rotated counter-clockwise, the protrusion (3343) is moved along the flat portions (3321) and the sloped portions (3322) and the tubular guide (332) is pushed to move upward with the force provided by the spring (333). When the protrusion (3343) rests on the highest flat portion (3321), the longest combined length of the protrusion (3343) and the tubular guide (332) is achieved. Accordingly, when the circle cutter is mounted on an object to be cut, the spring (333) will be compressed most. Therefore, due to the highest compression force of the spring (333), the replaceable tool (331) is pushed most downwardly by the spring (333) to get a deepest cutting depth. On the other hand, when the protrusion (3343) rests on the lowest flat portion (3321), the shortest combined length of the protrusion (3343) and the tubular guide (332) is achieved and the spring (333) may be compressed least by the object to be cut. When the protrusion (3343) rests on any flat portion (3321) between the highest and the lowest flat portions (3321), the replaceable tool (331) is pushed downwardly by the spring (333) to get a cutting depth between the aforementioned two extreme cutting depths.

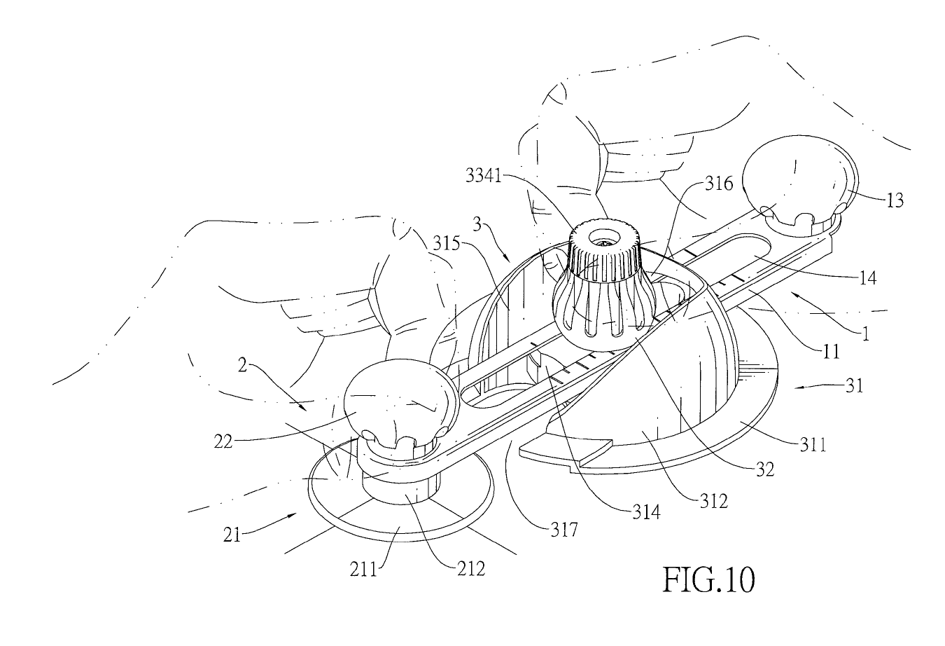

With reference to FIG. 10, to position a center of a circle to be cut or drawn on an object, the center positioning unit (2) is moved to the center of the circle by placing the foot (21) of the center positioning unit (2) near the location of the center of the circle. Then, the cross indicia on the foot (21) are aligned with two perpendicularly lines drawn and intersected at the center of the circle. Once the center of the circle is positioned, the center knob (22) is held and pressed by the user with one hand.

To adjust a radius of the circle to be cut, the base locker (32) is unscrewed from the tubular cutter holder (314) of the base (31) to make the base locker (32) away from the position where abuts against the ruler arm (11). The base locker (32) of the cutter unit (3) is then moved along the central slot (14) in the ruler arm (11) to a desired position corresponding to the radius of the circle based on the scale printed on the ruler arm (11). Then, the base locker (32) is screwed onto the tubular cutter holder (314) of the base (31) of the cutter unit (3) to abut against the ruler arm (11) and fix the desired position of the ruler arm (11) on the base (31).

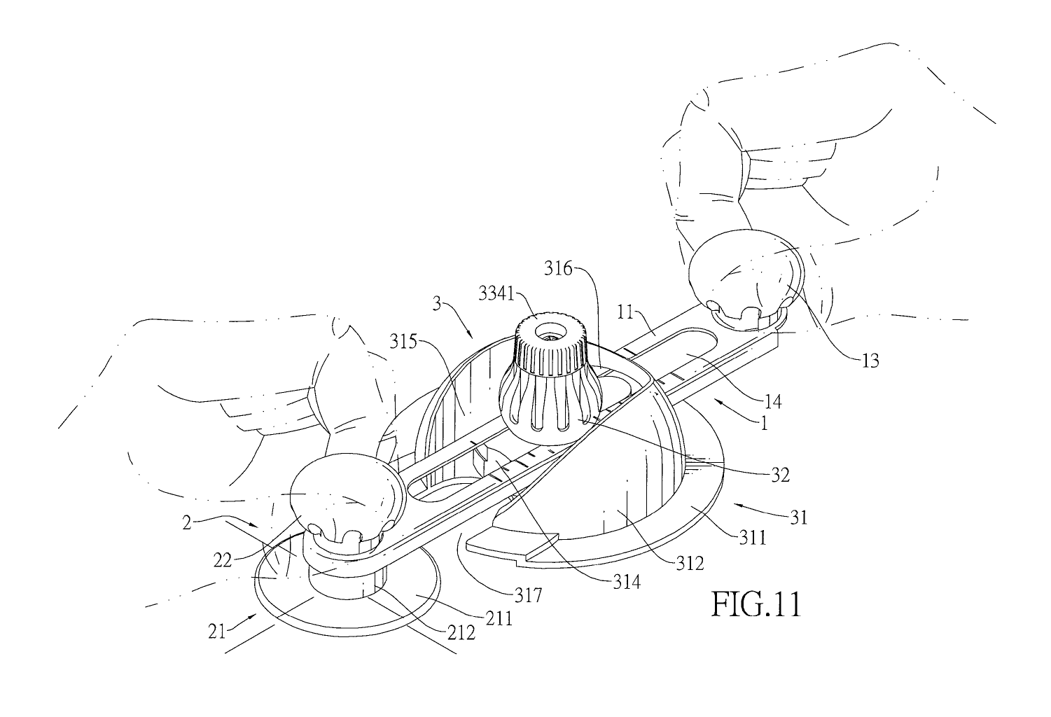

With reference to FIG. 11, to cut or draw the circle, the hand knob (13) of the hand crank (1) is held to either rotate the hand crank (1) clockwise or counter-clockwise with the foot (21) being a center to cut or draw the circle.

With such a circle cutter, the center positioning unit (2) of the circle cutter in accordance with the present invention is awl-free, a piercing hole at the center of a circle to be cut or drawn can be prevented. To cut objects with different thickness, multiple cutting depths are available by the adjustment of the cutting depth adjustable assembly. Because the center knob (22) and the hand knob (13) mounted respectively on two ends of the ruler arm (11) are held respectively by two hands of a user, the moment arm for driving the tool (331) can be prolonged. Thus, a labor-saving operation in cutting is provided.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A circle cutter comprising:
a hand crank having
a ruler arm;
a pivot hole formed through one end of the ruler arm;
a hand knob mounted on the other end of the ruler arm; and
a central slot formed through the ruler arm and located between the pivot hole and the hand button;
a center positioning unit mounted on the end of the ruler arm in which the pivot hole is formed and having
a foot; and
a center knob mounted through the pivot hole of the ruler arm and connected to the foot;
a cutter unit having
a base having
a dome-like wall formed on the base and having
an opening formed through a top and a side of the dome-like wall; and
a ruler slot formed through the dome-like wall and opposite to the side of the dome-like wall in which the opening is defined; and
a tubular cutter holder formed on the base and having a top end and a bottom end protruding respectively from a top and a bottom of the base and a blade hole formed through the tubular cutter holder, wherein the top end of the tubular cutter holder is located within the dome-like wall, is mounted slidably in the central slot of the ruler arm and has an outer thread mounted around the top end;
a base locker having a top bore and an inner thread and screwed with the tubular cutter holder to abut against the ruler arm so as to fix the ruler arm on the base; and
a cutting depth adjustable assembly mounted in the tubular cutter holder and having
a replaceable tool;
a tubular guide having multiple flat portions formed on a top of the tubular guide and multiple sloped portions spirally formed on the top of the tubular guide between the flat portions;
a spring, one end of the spring detachably inserted into a top of the replaceable tool, and the other end of the spring securely inserted into a bottom of the tubular guide; and
a cutting depth selector having
a dial;
a necked cylinder partially mounted in the base locker, and partially mounted through the top bore of the base locker and co-axially fastened on a bottom of the dial; and
a protrusion formed on a bottom of the necked cylinder, and abutting the top of the tubular guide so as to alternatively rest on the flat portions and move along the sloped portions of the portion of the tubular guide when the dial is rotated.

2. The circle cutter as claimed in claim 1 further comprising a protection guard mounted around and covering the replaceable tool of the cutter unit.

3. The circle cutter as claimed in claim 2, wherein the ruler arm has at least one scale formed on the ruler arm.

4. The circle cutter as claimed in claim 3, wherein the foot of the center positioning unit is made of a transparent material.

5. The circle cutter as claimed in claim 4, wherein the foot has cross indicia printed on the foot.

6. The circle cutter as claimed in claim 5, wherein
the foot comprises:
a round base; and
a neck centrally formed on the round base; and
the base further comprises:
a notch formed through an edge of the base to hold the neck of the foot; and
a circular recess formed in a bottom of the disk and around the notch to partially receive the round table.

7. The circle cutter as claimed in claim 1, wherein the replaceable tool is a blade.

8. The circle cutter as claimed in claim 2, wherein the replaceable tool is a blade.

9. The circle cutter as claimed in claim 3, wherein the replaceable tool is a blade.

10. The circle cutter as claimed in claim 4, wherein the replaceable tool is a blade.

11. The circle cutter as claimed in claim 5, wherein the replaceable tool is a blade.

12. The circle cutter as claimed in claim 6, wherein the replaceable tool is a blade.

13. The circle cutter as claimed in claim 1, wherein the replaceable tool is a pencil.

14. The circle cutter as claimed in claim 2, wherein the replaceable tool is a pencil.

15. The circle cutter as claimed in claim 3, wherein the replaceable tool is a pencil.

16. The circle cutter as claimed in claim 4, wherein the replaceable tool is a pencil.

17. The circle cutter as claimed in claim 5, wherein the replaceable tool is a pencil.

18. The circle cutter as claimed in claim 6, wherein the replaceable tool is a pencil.
